(19) United States
(12) Patent Application Publication
(10) Pub. No.: US 2015/0082687 A1
(43) Pub. Date: Mar. 26, 2015

(54) AUTOMATIC SELF FUNCTIONING FULL SEASON MOSQUITO LARVAE ERADICATOR

(71) Applicant: John D. Neff, Austin, TX (US)

(72) Inventor: John D. Neff, Austin, TX (US)

(21) Appl. No.: 14/038,636

(22) Filed: Sep. 26, 2013

(51) Int. Cl. A01M 1/12

(52) U.S. Cl. CPC A01M 1/12
USPC 43/111

(57) ABSTRACT

A portable, self-sustaining, automatic device for eliminating mosquito larvae operates throughout the entire mosquito breeding season. Mosquitos are lured to lay eggs in the stagnant water contained within a breeding bowl of the device. The subsequent larvae is disposed of by tipping the bowl or uncovering a bottom bowl opening to empty the bowl of water and larvae and kill the larvae in a timed cycle before they become mosquitoes. A water reservoir supplies sufficient water to replenish the bowl throughout the season. The device is solar powered and timed to correspond to mosquito breeding cycles.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to an insect eliminating device and in particular to a mosquito larvae eradicator device which has a reservoir of stagnant water to last an entire mosquito breeding season and a timed device for filling mosquito breeding bowl with a measured quantity of the stagnant water from the reservoir to attract mosquitoes and emptying the breeding bowl after a set time to kill mosquito larvae in the bowl, letting the bowl dry for a timed period and filling the bowl with stagnant water again to repeat the cycle providing an automatic and self-sufficient mosquito larvae eradication system for an entire mosquito breeding season, using a solar-power collector for an independent power supply.

2. Description of Related Art Including Information Disclosed Under 37 CFR 1.97 and 1.98

Mosquitoes are a global problem. Not only are mosquitoes a nuisance during outdoor activity, especially at night, but mosquitoes are also a major factor in transmitting diseases, which are sometimes lethal, from animals to people and also from person to person by extracting and distributing infectious blood.

Spraying to rid an area of mosquitoes may provide undesirable side effects due to allergies to the spray or even deaths from the spray, especially pet deaths. People may also apply substances to their bodies for keeping mosquitoes away while the people are outdoors, which may again cause harmful rashes and other allergic reactions in people and are sometimes not effective or wear off after a time or are washed off by water activity or perspiration.

None of the prior patents provide a self-sufficient device which works automatically for an entire mosquito breeding season without a need for external power or water refills or without requiring a constant supply of running water in the device to eradicate mosquito larvae before they become mosquitoes.

U.S. Pat. No. 6,708,443, issued Mar. 23, 2004 to Hall, claims an apparatus configured to provide standing water at convenient locations for the use of mosquitoes to lay eggs. After eggs are deposited in the development cycle of the egg, the larva, pupa, adult life stage are interrupted by denying the proper environment to sustain their development. Also disclosed is an apparatus to abate mosquito populations which provides a convenient and attractive reservoir of liquid situated to encourage use by mosquitoes for egg laying. At intervals the liquid in the reservoir is flushed or filtered eliminating mosquito biomass developing in the liquid. The bio-matter is substantially removed and aborts the development of the bio-matter into adult insects.

U.S. Pat. No. 6,338,220 issued Jan. 15, 2002 to Dicks, provides a method of eradicating mosquitoes, which includes the steps of inducing female mosquitoes to lay their eggs in the vicinity of water contained in an open-topped container provided for the purpose, causing the larvae in which form the eggs hatch to live in the water. The water is then emptied from the container together with the larvae, before the larvae changes into the adult form of mosquitoes, resulting in the larvae dying because of the larvae not being exposed to water. The invention relates also to apparatus provided for carrying out the above method repetitively over extended time periods.

U.S. Pat. No. 8,109,035 (and U.S. Pat. No. 7,694,455), issued Feb. 7, 2012 both to Bowden, et al., are for a mosquito control trap that takes advantage of the normal stages of development for a mosquito. The trap includes stagnant water trapped within a container by a weeping platform floating on top of the water. A series of holes in the weeping platform provide exposure of the water to form brood cups in which female mosquitoes lay eggs. In order to develop through the larva and pupa stage the developing insects must enter the larger reservoir of stagnant water, since there is insufficient room in the brood cups. However, the holes are too small to permit escape of the adult mosquito, thus preventing any of the eggs from developing. This device provides a means for controlling mosquitoes without the use of pesticides and is especially suitable for use in lesser developing countries.

U.S. Pat. No. 7,434,351, issued Oct. 14, 2008 to Bette, shows a device into which gravid (pregnant) female mosquitoes are attracted to deposit their eggs and where both the adult and her offspring are then eliminated. The trap is set in the out-of-doors at the onset of the mosquito breeding season and is replenished by rain water and, by its unique construction, a larvicide within is protected from flushing and photo degradation thereby making it maintenance free throughout the mosquito breeding season. The low cost trap is constructed from biodegradable paperboard and at the end of the mosquito breeding season, decomposes, thereby foreclosing the possibility that the trap will become a breeding incubator.

U.S. Pat. No. 7,448,160, issued Nov. 11, 2008 to Roberts, discloses a mosquito harvest trap which includes a control unit, a holding chamber and a water tank. The trap is based on water column technology being used to harvest and expel mosquito larvae residing within the water column.

U.S. Pat. No. 7,536,824, issued May 26, 2009 to Durand, et al., provides a system for trapping flying insects, utilizing carbon dioxide in conjunction with one or more biochemical lures, visual lures or both. Preferably, a biochemical lure such as lactic acid, a salt of lactic acid, or combinations thereof, are employed in particular geometric shapes contained in specifically designed housing to ensure an effective release rate over extended periods of time.

What is needed is a self-sufficient device which works automatically for an entire mosquito breeding season without a need for external power or water refills or without requiring a constant supply of running water in the device to eradicate mosquito larvae before they become mosquitoes.

### BRIEF SUMMARY OF THE INVENTION

An object of the present invention is to provide a self-sufficient automatically and independently functioning full season system to eliminate mosquitoes during the entire breeding season by destroying the mosquito larvae before they become mosquitoes with a self-sufficient water tank reservoir supply and solar powered electrical power.

Another object is to provide pre-filtering of water added to a full-breeding-season size reservoir and water automatically transferred into the breeding bowl as needed to rid the water of various water purifiers and preservers and adding chlorine and oxygen reducer to the water in the reservoir or in the breeding bowl to further assist the water in the tank and breeding bowl to become stagnant to attract mosquitoes to lay their eggs in the breeding bowel.

A further object of the present invention is to provide a self-sufficient automatic system which is self-operating for the entire mosquito breeding season, including automatically dumping the breeding bowl at timed intervals for killing mosquito larvae and allowing time for the bowl to dry out before automatically filling the bowl again with the pre-filtered water, which resembles stagnant water, to attract mosquitoes to lay eggs in the breeding bowl.

In brief, the present invention provides a large reservoir tank of water sufficiently large to supply a mosquito larvae eradicator device for a full season of mosquito breeding. The water added to the reservoir or tank is preferably pre-filtered to remove water purifiers and preservatives to make the water become stagnant. Added to the water reservoir or tank, a chlorine and oxygen reducer will further assist to make the water become stagnant. Chloride and oxygen and any other possible water purity preservatives are further filtered out of the water as it is dispensed periodically from the tank to the breeding bowl to allow the water in the breeding bowl to become more stagnant and resemble stagnant swamp and puddle water preferred by mosquitoes for breeding mosquito larvae.

The present invention provides an automatic system which is self-operating for the entire mosquito breeding season, including automatically emptying the breeding bowl at timed intervals for killing mosquito larvae and allowing time for the bowl to dry out before automatically filling the bowl again from the tank through the filter and into the breeding bowl. The treated and filtered water, which resembles stagnant water, attracts mosquitoes to lay eggs in the breeding bowl, and emptying the water after a period of time allowing for the hatching of the mosquito eggs into mosquito larvae will then kill the mosquito larvae and prevent the development of the larvae into mosquitoes. Allowing the breeding bowl to dry out further insures that all of the larvae will be eradicated.

While the time cycles of the operation of the present invention may vary according to climate differences which affect evaporation and drying time and differences in mosquito species and their breeding cycles, the preferred average cycles for a temperate climate with temperate climate mosquitoes are as follows. One version of the invention works with approximately 16 oz. of stagnant water in the breeding bowl left for 4-7 days and then the water is emptied out and the breeding bowl left to dry out for approximately 12 hours to make sure it is dry. Then the breeding bowl is refilled and the cycle repeated for the entire breeding season of the mosquitoes. The reservoir tank holds sufficient water (at least four gallons) to repeatedly refill the breeding bowl according to the most effective timing cycles for the entire mosquito breeding season. Depending on the number of mosquito larvae eradicating devices used and how closely spaced they are, a large area may be made relatively mosquito free for an entire mosquito breeding season.

An advantage of the present invention is that it provides a completely self-sufficient mosquito eradicating device with a self-contained full breeding season water supply which operates independently of any other water supply for an entire mosquito breeding season.

Another advantage of the present invention is that it provides regularly timed water emptying, drying, and re-filling with stagnant water stored within the device and including pre-filtering and adding materials to eliminate chlorine and oxygen and other water purifying elements to provide an internal stagnant water for the breeding bowl to attract mosquitoes to lay their eggs in the breeding bowl, the timing coinciding with the time for mosquito eggs to hatch into mosquito larvae.

A further advantage of the present invention is that the breeding bowl of stagnant water is sufficiently deep so the water will not evaporate during the mosquito larvae breeding cycle.

One more advantage of the present invention is that solar power provides a totally independent power source so that the mosquito larvae eradicator device can be used in areas remote from electrical power sources.

Still another advantage of the present invention is that with filtering and adding chlorine and oxygen reducers, the stagnant water in the breeding bowl resembles stagnant swamp and puddle water preferred by mosquitoes for breeding mosquito larvae.

### BRIEF DESCRIPTION OF THE SEVERAL VIEWS OF THE DRAWINGS

These and other details of the present invention will be described in connection with the accompanying drawings, which are furnished only by way of illustration and not in limitation of the invention, and in which drawings:

FIG. 1 is a diagrammatic elevational view of the assembled components of the mosquito larvae eradication device of the present invention showing the breeding bowl in the horizontal position for holding the stagnant water to attract mosquitoes to lay their eggs in the stagnant water to hatch them into larvae;

FIG. 2 is a diagrammatic elevational view of the assembled components of the mosquito larvae eradication device of FIG. 1 showing the breeding bowl in the vertical position for dumping out the stagnant water and mosquito larvae and to allow the breeding bowl to dry out;

FIG. 3 is a diagrammatic front elevational view of the assembled components of the mosquito larvae eradication device of the present invention showing an alternate breeding bowl fixed in the horizontal position for holding the stagnant water to attract mosquitoes to lay their eggs in the stagnant water to hatch them into larvae, the breeding bowl being immovably attached to the timed operating device housing and having a bottom opening plate and an optional covering screen;

FIG. 4 is an axial cross-sectional side elevational view of the breeding bowl of FIG. 3 showing the bottom water dumping plate in a closed position blocking the opening in the bottom of the breeding bowl;

FIG. 5 is an axial cross-sectional side elevational view of the breeding bowl of FIG. 3 showing the bottom water dumping plate in a lowered position under the opening in the bottom of the breeding bowl;

FIG. 6 is a diagrammatic rear elevational view of the assembled components of the mosquito larvae eradication device of FIG. 3 showing the bottom water dumping plate in a lowered position pivoted away from the opening in the bottom of the breeding bowl to release the water and larvae from the breeding bowl.

### DETAILED DESCRIPTION OF THE INVENTION

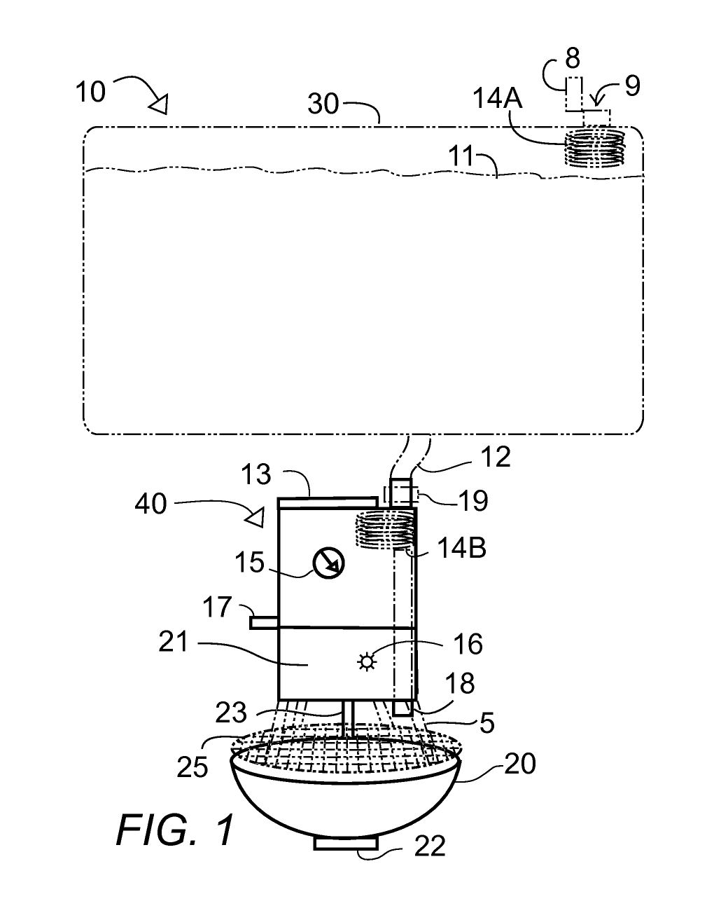

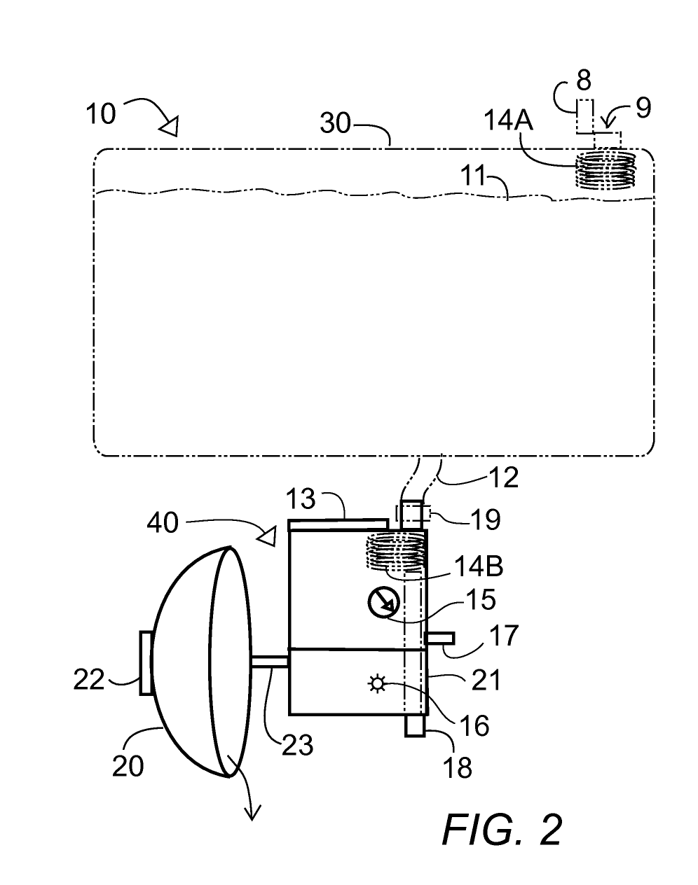

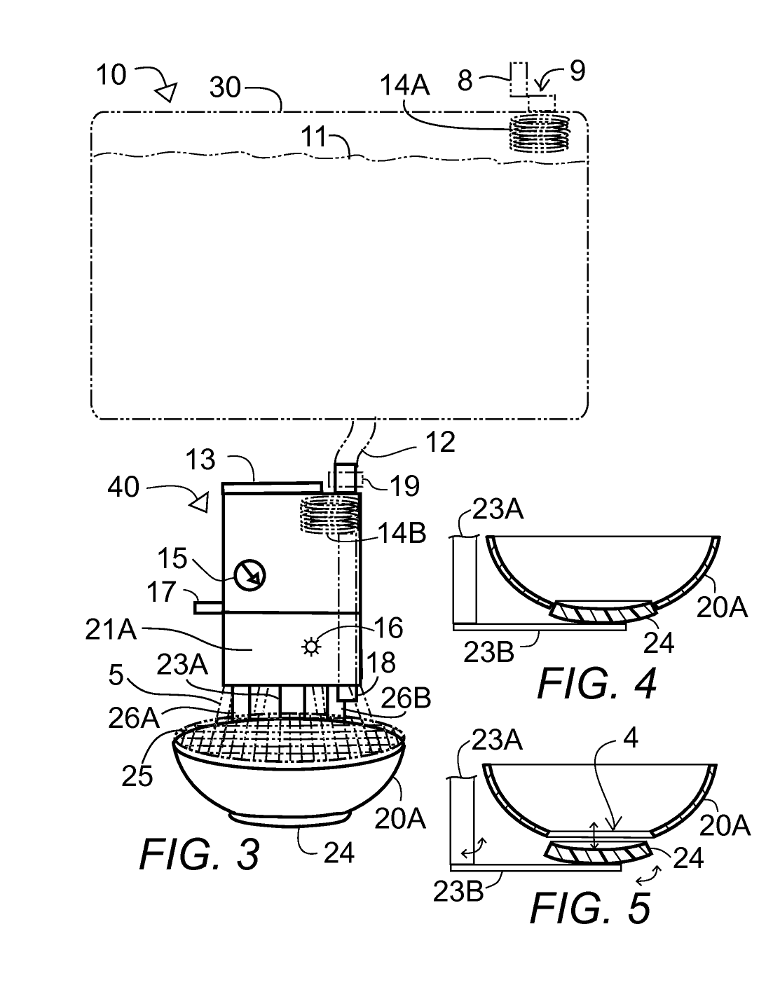

In FIGS. 1-6, an automatic self-functioning full season mosquito larvae eradicator device 10 comprises a reservoir tank 30, a breeding bowl 20, a timed control operating device 40 with a bowl tipping device 21, bowl tipping arm 23 and a bowl tipping arm base 22 for tipping the breeding bowl 20 in FIGS. 1 and 2 and an alternate stationary breeding bowl 20A with a water releasing bottom plate 24 over a bottom bowl opening 4 in FIGS. 3-6, an associated timer 15, a bowl fill tube 12, a bowl filling spout 18, a water controlling valve 19, a bowl filter 14B, a CO₂ mister 17, an infrared light 16, at least one solar panel 13 for power, and an optional screen 25 over the bowl to prevent birds and animals from accessing the water in the bowl.

The reservoir tank 30 containing the water 11 is sufficiently large to supply a mosquito larvae eradicator device 10 for a full season of mosquito breeding. The tank 30 further comprises a fill spout 9 with a cover 8 and a tank water filter 14A to filter out water purifiers from the water 11. A chlorine and oxygen reducer is added to a full-breeding season supply of water 11 in the tank 30 to assist the water in the tank to become stagnant for mosquito larvae breeding.

The breeding bowl 20 and 20A is positioned lower than the reservoir tank 30 to receive water from the tank 30. The breeding bowl 20 and 20A is structured to contain a stagnant pool of water with an open top water surface for allowing mosquitoes to lay eggs on the water surface that then produce mosquito larvae during a mosquito breeding cycle. The breeding bowl 20 is sufficiently deep to prevent evaporation of all of the water 11 during the mosquito larvae producing cycle.

In FIGS. 1 and 2, the breeding bowl 20 is held by the bowl tipping arm 23 and is seated on the bowl tipping arm base 22. In FIGS. 3-6, an alternate breeding bowl 20A is immovably attached by brackets 26A and 26B to the timed operating device 40 housing and has a bottom opening plate 24 blocking a bottom bowl opening 4, is shown in FIGS. 3 and 4.

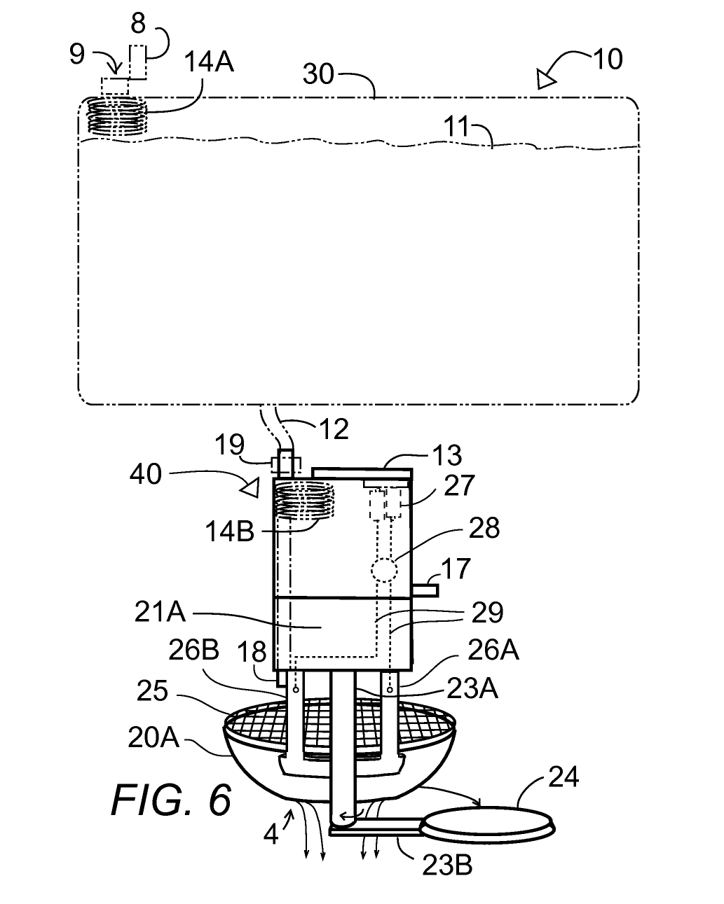

A timed control operating device 40 comprises a timed bowl manipulating device 21 that has the means for tipping the breeding bowl 20 from a first substantially horizontal position, as shown in FIG. 1, for maintaining the water 11 and the mosquito larvae in the bowl 20, to a second vertical position, as shown in FIG. 2 for emptying the water 11 and the mosquito larvae from the bowl 20 to destroy the mosquito larvae in a timed, recurring cycle corresponding to the breeding cycle required for producing the mosquito larvae in the water 11 in the bowl 20. In FIGS. 3-6, alternatively the timed bowl manipulating device 21A has the means for lowering and pivoting the bottom water dumping plate 24 into a second lowered position pivoted away from the opening 4 in the bottom of the breeding bowl 20A, as shown in FIGS. 5 and 6, to release the water and larvae from the breeding bowl 20A through the bottom bowl opening 4. The timed bowl tipping device 21 also has the means for maintaining the bowl 20 in the second substantially vertical position, as shown in FIG. 2, and alternately the plate pivoting device 2A for maintaining the bottom plate 24 in the second position away from the bottom bowl opening 4, as shown in FIG. 6, both sufficiently long to allow the bowl 20 and 20A to dry, and then restoring the bowl 20 to the first horizontal position, as shown in FIG. 1, or alternatively restoring the bottom plate 24 to the blocking position, as shown in FIG. 3, for receiving a new supply of stagnant water 11 to repeat the mosquito larvae breeding and eradicating cycle.

The timed bowl tipping device 21 and plate pivoting device 21A can be operated by, but is not limited to, a motor or solenoid. The timed plate pivoting device 21A is preferably operated by a motor or solenoid in combination with a screw drive in the control column 23A to lower and raise and pivot the plate support arm 23B.

A timed control operating device 40 is programmed to operate the timed bowl tipping device 21 or the plate pivoting device 21A. The timed control operating device 40 also operates a timed control valve 19, between the reservoir tank 30 of water 11 and the breeding bowl 20 and 20A, for releasing a measured amount of water 11 from the reservoir tank 30 to fill the breeding bowl 20 and 20A each time the bowl 20 is raised to the first horizontal position, as shown in FIG. 1 or the bottom plate 24 is pivoted and raised to the bowl opening blocking position, as shown in FIG. 3. The timed control operating device 40 also contains a bowl water filter 14B between the reservoir tank 30 and the breeding bowl 20 and 20A, for filtering out any further water purifying content of the water 11 from the tank 30 to the bowl 20 and 20A to further insure stagnant water in the bowl 20 and 20A for attracting mosquitoes to use the water for breeding mosquito larvae.

There is at least one solar panel 13 attached to the timed control operating device 40 for producing electricity from sunlight to store in at least one power storage device to power the mosquito larvae eradicator device 10 to further enable automatic self-functioning operation of the timed control operating device 40, thereby providing an automatic self-functioning full season mosquito larvae eradicator device.

The mosquito larvae eradicator device 10 also contains a means for giving off Carbon Dioxide, a CO₂ mister 17, attached to the timed control operating device 40, to dispense Carbon Dioxide into the air surrounding the mosquito larvae eradicator device 10 to attract mosquitoes to the device.

The mosquito larvae eradicator device 10 also contains a means for shining infrared light 16 attached on the outside of the timed control operating device 40 to attract mosquitoes to the mosquito larvae eradicator device 10.

The mosquito larvae eradicator device 10 has a timer 15 for the timed control operating device 40, which provides a timed, four-day cycle for emptying and re-filling the breeding bowl 20 and a twelve-hour cycle for drying the breeding bowl 20 and 20A, before refilling.

In FIGS. 1, 3, and 6, an optional wide mesh screen 25 hung by brackets 5 from the timed control device 40 housing, is positioned over the top opening of the breeding bowl 20 and 20A to prevent birds and animals from accessing the water to prevent them from drinking or bathing in the water.

In FIG. 6, batteries 27 are shown inside the timed control operating device 40 housing adjacent to the exterior solar panel 13. Optional wires 19 run from the batteries through an electrical switch 28 to the brackets 26A and 26B securing the stationary breeding bowl 20A, which is preferably at least partially fabricated or partially coated with an electrically conductive material. The electrical switch 28 is operated by the timer, so that the breeding water in the breeding bowl 20A can be shocked at timed intervals to kill the mosquito larvae in the breeding bowl 20A as a supplement to emptying the water or an alternative to emptying the water if the water dumping devices malfunction.

In use, a number of mosquito larvae eradicator devices would be set up in an area, which could be remote and without electricity or water. The water tank is filled and the timer is set, then the device is activated. At timed intervals, corresponding to breeding and larvae hatching cycles, the breeding bowl is filled with stagnant water, attracting mosquitos to lay eggs in the water. After eggs have turned to larvae, the bowl tipping mechanism tips the larvae infested water out of the bowl and allows the bowl to dry before refilling. The device, being powered by at least one solar panel, must be in a location where the solar panel gets adequate sunlight to keep the device going throughout the entire mosquito season.

It is understood that the preceding description is given merely by way of illustration and not in limitation of the invention and that various modifications may be made thereto without departing from the spirit of the invention as claimed.

What is claimed is:

1. An automatic self-functioning full season mosquito larvae eradicator device comprising:
a reservoir tank of water sufficiently large to supply a mosquito larvae eradicator device for a full season of mosquito breeding, the tank further comprising a tank water filter to filter out water purifiers from the water and a chlorine and oxygen reducer added to a full-breeding season supply of water in the tank to assist the water in the tank to become stagnant for mosquito larvae breeding;
a breeding bowl positioned lower than the reservoir tank to receive water from the reservoir tank, the breeding bowl structured to contain a stagnant pool of water with an open top water surface for allowing mosquitoes to lay eggs on the water surface for producing mosquito larvae in a mosquito breeding cycle;
a timed control operating device comprising a timed bowl manipulating device having means for emptying the breeding bowl from a first condition for maintaining the water and the mosquito larvae in the bowl to a second condition for emptying the water and the mosquito larvae from the bowl to destroy the mosquito larvae in a timed recurring cycle corresponding to a breeding cycle required for producing the mosquito larvae in the water in the bowl, means for maintaining the bowl in the second empty condition sufficiently long to allow the bowl to dry, means for restoring the bowl to the first condition for receiving a new supply of stagnant water to repeat the mosquito larvae breeding and eradicating cycle;
a timed water control device associated with the timed bowl manipulating device, the timed water control device comprising a timed control valve between the reservoir tank of water and the breeding bowl for releasing a measured amount of water from the reservoir tank to fill the breeding bowl each time the bowl is the first condition for receiving and maintaining water, the timed water control device further comprising a bowl water filter between the reservoir tank and the breeding bowl for filtering out any further water purifying content of the water from the tank to the bowl to further insure stagnant water in the bowl for attracting mosquitoes to use the water for breeding mosquito larvae;
at least one solar panel for producing electricity from sunlight to store in at least one power storage device to power the mosquito larvae eradicator device to further enable automatic self-functioning operation of the mosquito breeding device;
thereby providing an automatic self-functioning full season mosquito larvae eradicator device.

2. The mosquito larvae eradicator device of claim 1 wherein the breeding bowl is supported by a bowl tipping arm and the timed bowl manipulating device comprises means for tipping the breeding bowl from a first substantially horizontal position in the first condition for maintaining the water and the mosquito larvae in the bowl to a second vertical position in the second condition for emptying the water and the mosquito larvae from the bowl to destroy the mosquito larvae in a timed recurring cycle corresponding to a breeding cycle required for producing the mosquito larvae in the water in the bowl, means for maintaining the bowl in the second substantially vertical position sufficiently long to allow the bowl to dry, means for restoring the bowl to the first horizontal position for receiving a new supply of stagnant water to repeat the mosquito larvae breeding and eradicating cycle.

3. The mosquito larvae eradicator device of claim 1 wherein the breeding bowl is immovable and the breeding bowl has a bottom bowl opening and further comprising a movable opening plate normally in a first position in the first condition blocking the bottom bowl opening and the timed bowl manipulating device comprises means for lowering and pivoting the movable opening plate into a second lowered position in the second condition pivoted away from the bottom bowl opening to release the water and larvae from the breeding bowl through the bottom bowl opening to destroy the mosquito larvae in a timed recurring cycle corresponding to a breeding cycle required for producing the mosquito larvae in the water in the bowl, and further comprises means for maintaining the opening plate in the second position away from the bottom bowl opening sufficiently long to allow the bowl to dry, and then restoring the opening plate to the blocking position for receiving a new supply of stagnant water in the breeding bowl to repeat the mosquito larvae breeding and eradicating cycle.

4. The mosquito larvae eradicator device of claim 1 further comprising means for giving off Carbon Dioxide attached to the mosquito larvae eradicator device, the means for giving off Carbon Dioxide dispensing Carbon Dioxide to the air surrounding the mosquito larvae eradicator device to attract mosquitoes to the mosquito larvae eradicator device.

5. The mosquito larvae eradicator device of claim 1 further comprising means for shining infrared light attached on the outside of the mosquito larvae eradicator device, the means for shining infrared light producing infrared light around the mosquito larvae eradicator device to attract mosquitoes to the mosquito larvae eradicator device.

6. The mosquito larvae eradicator device of claim 1 wherein the breeding bowl is sufficiently deep to prevent evaporation of all of the water during the mosquito larvae producing cycle.

7. The mosquito larvae eradicator device of claim 1 comprising a timed four day cycle for emptying and re-filling the breeding bowl and a twelve hour cycle for drying the breeding bowl.

8. The mosquito larvae eradicator device of claim 1 further comprising a wide mesh screen to cover a top opening in the breeding bowl to prevent birds and animals from accessing the water in the breeding bowl.

9. The mosquito larvae eradicator device of claim 1 further comprising at least one electrical conductor between the at least one power storage device and at least a portion of the breeding bowl contacting the water in the breeding bowl and controlled by the timed control operating device to send timed periodic electrical shocks to the water sufficient to kill the mosquito larvae.
